(19) United States
(12) Patent Application Publication
(10) Pub. No.: US 2022/0259039 A1
(43) Pub. Date: Aug. 18, 2022

(54) CHEMICAL CONVERTER FOR PRODUCTION OF HYDROGEN GAS

(71) Applicant: Trulite, Inc., Elgin, SC (US)

(72) Inventors: Robert T. STEWART, JR., Lexington, SC (US); Jeffrey D. ROCKEL, Bishopville, SC (US); Ronald G. SEFTICK, Elgin, SC (US)

(21) Appl. No.: 17/672,994

(22) Filed: Feb. 16, 2022

Related U.S. Application Data
(60) Provisional application No. 63/278,044, filed on Nov. 10, 2021.
(60) Provisional application No. 63/150,669, filed on Feb. 18, 2021.

(51) Int. Cl. C01B 3/06; B65D 88/28; B65D 88/30; B01J 19/00; B01J 19/18; B01J 8/00

(52) U.S. Cl. CPC C01B 3/065; B65D 88/28; B65D 88/30; B01J 19/0006; B01J 19/0086; B01J 19/1812; C01B 2203/1642; B01J 8/003; B01J 2219/00022; B01J 2219/00029; C01B 2203/1205; C01B 2203/1628; B01J 8/0035

(57) ABSTRACT

An apparatus for producing hydrogen gas is provided. The apparatus includes a first hopper having a reaction chemical. The reaction chemical includes sodium borohydride (NaBH₄) and a chemical component. The chemical component may be magnesium chloride (MgCl₂). The apparatus also includes a reaction chamber. The reaction chamber has an input for receiving the reaction chemical from the first hopper and an output for removal of hydrogen gas. The apparatus also includes a second hopper for containing spent solid chemical mixture removed or extracted from the reaction chamber.

### CROSS-REFERENCE TO RELATED APPLICATIONS

This application is a utility application claiming priority from U.S. provisional patent application Ser. No. 63/150,669, filed on Feb. 18, 2021, and from U.S. provisional patent application Ser. No. 63/278,044, filed on Nov. 10, 2021, in the United States Patent and Trademark Office. The disclosures of which are incorporated herein by reference in their entireties.

### FIELD OF THE INVENTION

The present invention relates to hydrogen gas production, more particularly to a stationary chemical converter to produce hydrogen gas.

### BACKGROUND OF THE INVENTION

Hydrogen as an energy source has been slow in implementation in the United States and world markets due to safety concerns, emissions, and high costs to safely produce, transport and store compressed or liquid hydrogen.

Present technology to produce hydrogen gas includes reforming natural gas or propane gas at very high temperatures that create emissions and then compressing to high pressures for transport. Another known method is electrolysis which uses very large amounts of electricity and purified water to produce hydrogen gas which is then compressed to high pressures for transport. Compressed gas transport requires specialized tube trailers and all outdoor storage in secured areas.

Thus, there is the need for a system and method for production of hydrogen gas that overcomes the aforementioned disadvantages and problems of known systems and methods.

### SUMMARY OF THE INVENTION

The present invention relates to a system and method for producing hydrogen gas. In various embodiments, hydrogen gas may be produced on demand, at a user location. In various embodiments, systems and methods are provided for closed loop-controlled operation and may use easily transported chemicals that can be reacted with very low-cost and easily available reactants. Various embodiments solve problems with known methods for production of hydrogen, and embodiments are provided with applicability across a wide range of industries including, but not limited to, automotive, material movers, uninterrupted power supplies (UPS), and telecommunications, among others. The low pressure, safe chemicals, and reactants of the various embodiments may allow for indoor storage and use in a wide variety of applications.

A stationary chemical converter may be utilized as a reaction chamber, and this stationary chemical converter may be used to produce hydrogen gas at a lower pressure and at a lower temperature. Approaches utilizing high temperatures and high pressures present safety problems, and a stationary chemical converter may provide a safe method to produce hydrogen gas. Various embodiments may also eliminate emissions, hazardous chemicals, and hazardous waste.

In an embodiment of the invention, a method comprising metering a dry chemical or chemical mixture into a reaction chamber partially filled with reactant at a computer-controlled rate to maintain pressure of pure-hydrogen gas output at near room temperatures is provided. Methods of controlling chemical balance may also be used to monitor, control, and maintain hydrogen output and to assure that chemical residue in the reaction chamber is not a hazardous waste. A reaction chamber may be provided that is designed to remove spent solid chemical mixture and deposit in an empty fuel supply hopper for return and regeneration. The reaction chamber may be designed to have a wash and surface water cycle that will remove any residue in the reaction chamber. The wash and surface water cycle may also discharge a pH balanced low mineral or salt content discharge allowed by municipal sewage systems. Various embodiments may utilize a mixture of sodium borohydride (NaBH₄) and magnesium chloride (MgCl₂) with tap water, sea water, or filtered surface water as reactant.

Humidity control may be added for gas to be compressed to high pressure. Dehumidification may not be required where a direct feed to a fuel cell is utilized.

In an embodiment of the invention, a method for producing hydrogen gas is provided. The method comprises: metering a reaction chemical at a controlled rate into a reaction chamber containing water, wherein a reaction thereby occurs in the reaction chamber releasing hydrogen gas, and wherein the reaction chemical comprises sodium borohydride (NaBH₄) and a chemical component.

In an embodiment of the invention, a system for producing hydrogen gas is provided. The system comprises: a first hopper comprising a reaction chemical, wherein the reaction chemical comprises sodium borohydride (NaBH₄) and a chemical component, and wherein the chemical component is magnesium chloride (MgCl₂); a reaction chamber having an input for receiving the reaction chemical from the first hopper and having an output for removal of hydrogen gas; and a second hopper for containing a spent chemical mixture removed or extracted from the reaction chamber.

In an embodiment of the invention, a system for producing hydrogen gas is provided. The system comprises: a first hopper configured to hold a reaction chemical; a second hopper configured to hold a spent chemical mixture; a reaction chamber connected to the first hopper and the second hopper and positioned between the first hopper and the second hopper, the reaction chamber having an input for receiving the reaction chemical from the first hopper; an output vent for removal of hydrogen gas; a gas valve that is configured to permit or prevent flow of gas through the output vent; an output for removal of the spent chemical mixture to the second hopper; and at least one pressure sensor; and an electrical system having a comparator, wherein the electrical system is configured to: receive a first value from the at least one pressure sensor; compare the first value to an upper limit using the comparator; open the gas valve or retain the gas valve in an open state if the first value is greater than or equal to the upper limit.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, which are not necessarily to scale, wherein:

FIG. 1A is a diagram of a system for production of hydrogen gas, the system in accordance with the present invention.

FIG. 1B is a perspective view illustrating an example hydrogen production system in accordance with an embodiment of the present invention.

FIG. 1C is a rear view illustrating the example hydrogen production system of FIG. 1B in accordance with an embodiment of the present invention.

FIG. 1D is a left-side view illustrating the example hydrogen production system of FIG. 1B in accordance with an embodiment of the present invention.

FIG. 1E is a top view illustrating the example hydrogen production system of FIG. 1B in accordance with an embodiment of the present invention.

FIG. 1F is a perspective view illustrating the example hydrogen production system of FIG. 1B where a top hopper is positioned over a reaction chamber in accordance with an embodiment of the present invention.

FIG. 1G is a perspective view illustrating the example hydrogen production system of FIG. 1B where a top hopper and pallet rack are shifted to a loading zone 124 in accordance with an embodiment of the present invention.

FIG. 2A is a schematic view illustrating an example hydrogen production system in accordance with an embodiment of the present invention.

FIG. 2B is a schematic view illustrating a reaction chamber in accordance with an embodiment of the present invention.

FIG. 3A is a right-side view illustrating an example hydrogen production system in accordance with an embodiment of the present invention.

FIG. 3B is a cross-sectional view illustrating the example hydrogen production system of FIG. 3A in accordance with an embodiment of the present invention.

FIG. 3C is an enhanced view illustrating the connection of a top hopper and a reaction chamber in accordance with an embodiment of the present invention.

FIG. 4A is a perspective view illustrating an example hopper in accordance with an embodiment of the present invention.

FIG. 4B is a right-side view illustrating the example hopper of FIG. 4A in accordance with an embodiment of the present invention.

FIG. 4C is a front view illustrating the example hopper of FIG. 4A in accordance with an embodiment of the present invention.

FIG. 5A is an electrical diagram illustrating the operation of a system for managing the pressure within a vessel in accordance with an embodiment of the present invention.

FIG. 5B is an electrical diagram illustrating an electrical circuit for limiting the voltage supplied to a digital to analog converter in accordance with an embodiment of the present invention.

FIGS. 5C-5F are electrical diagrams illustrating example approaches for controlling one or more gas valves in accordance with an embodiment of the present invention.

FIG. 6 is a block diagram illustrating various components that may be connected to processing circuitry in accordance with an embodiment of the present invention.

FIG. 7 is a flow chart illustrating an example method for producing hydrogen gas in accordance with an embodiment of the present invention.

### DESCRIPTION OF THE PREFERRED EMBODIMENTS

The following description of the embodiments of the present invention is merely exemplary in nature and is in no way intended to limit the invention, its application, or uses. The following description is provided herein solely by way of example for purposes of providing an enabling disclosure of the invention, but does not limit the scope or substance of the invention.

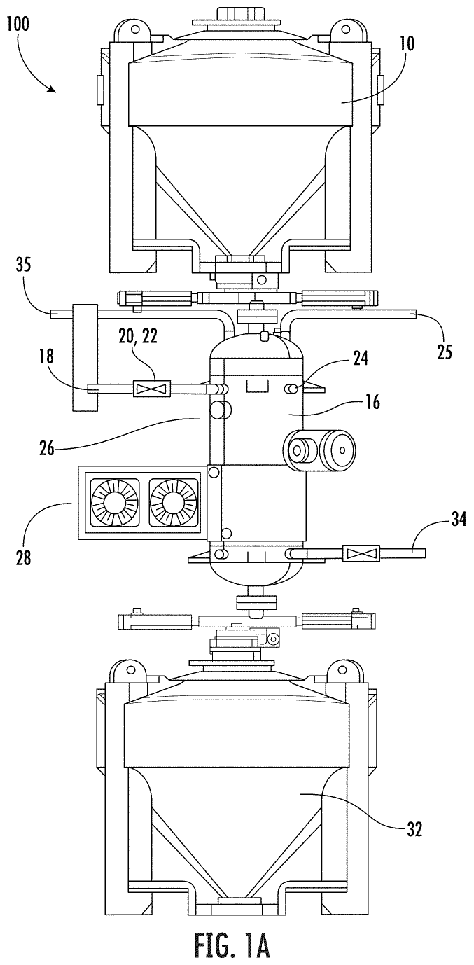

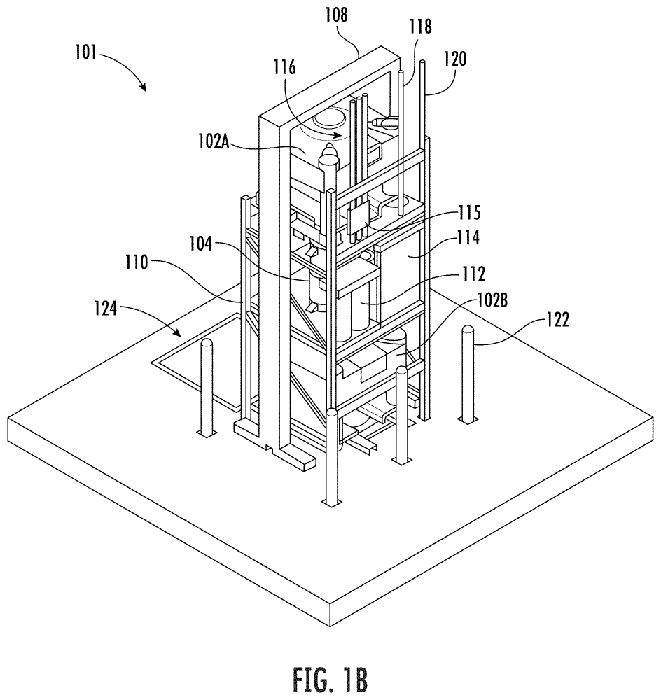

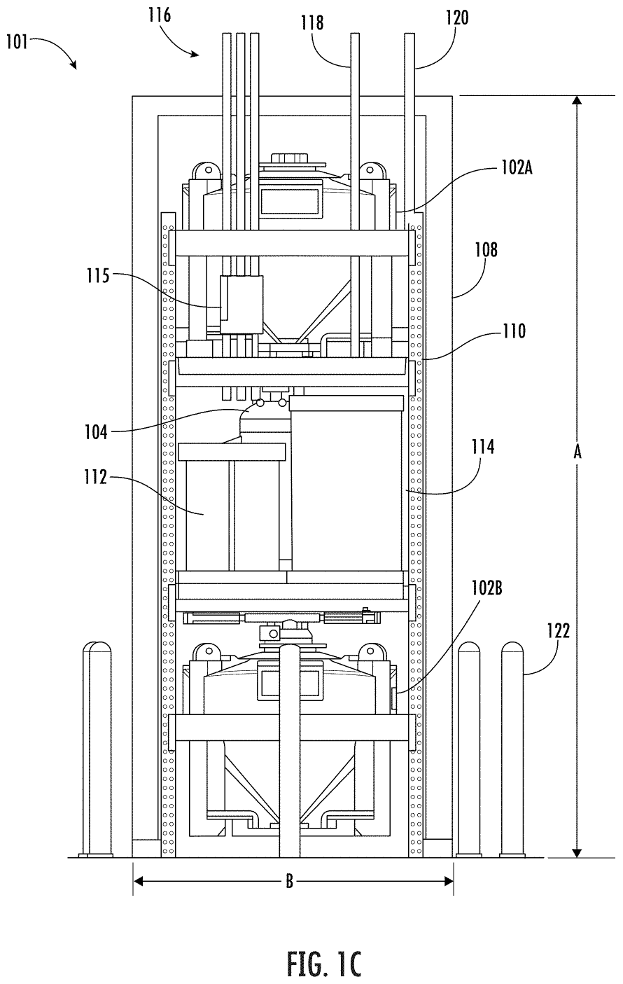

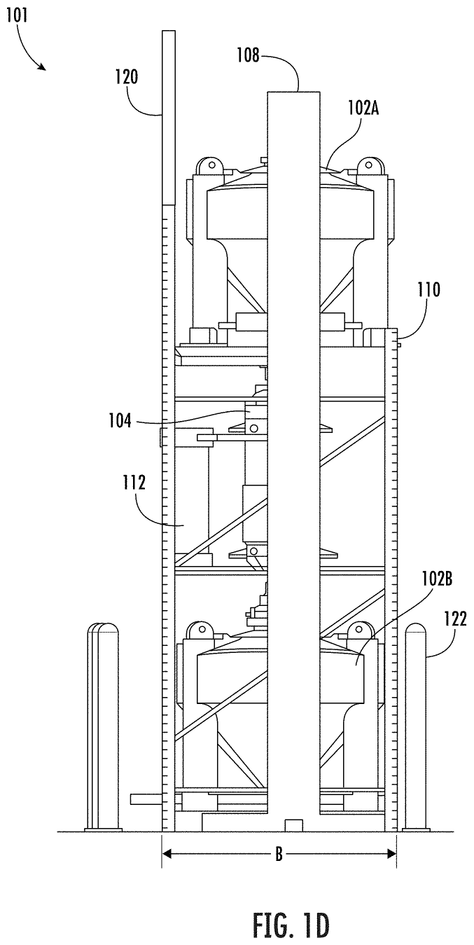

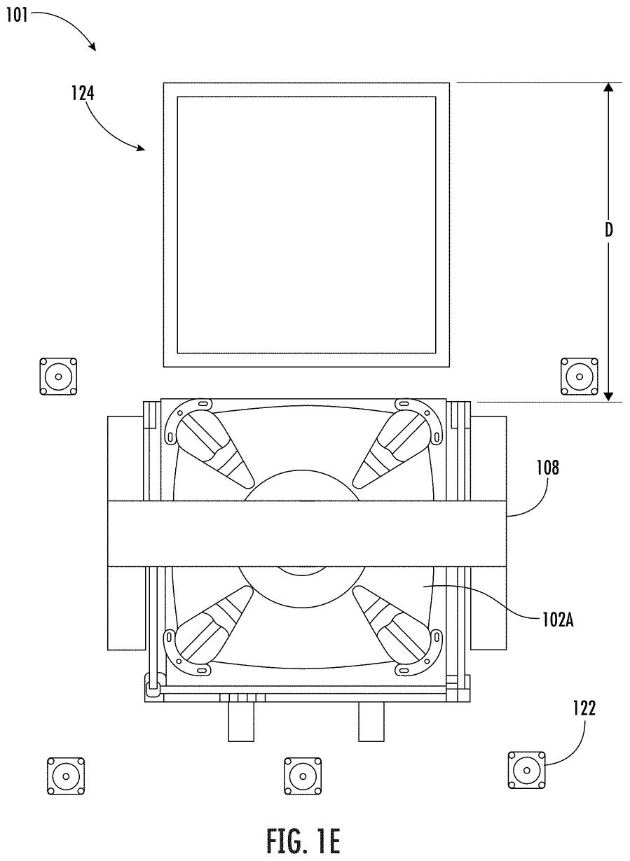

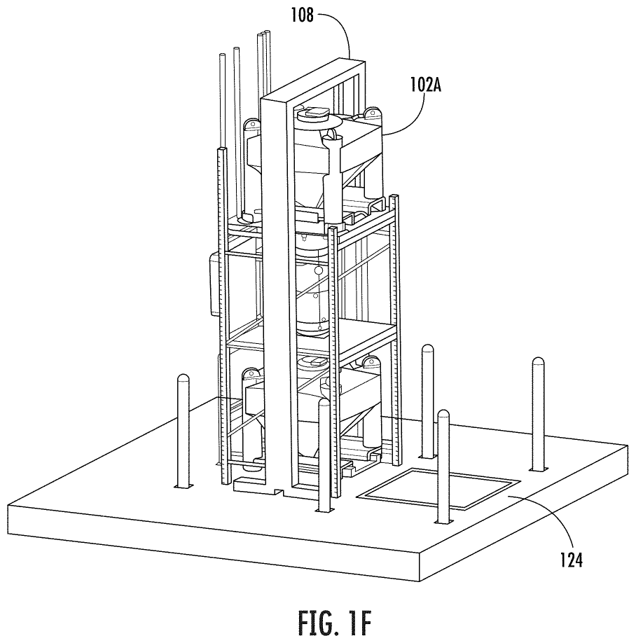

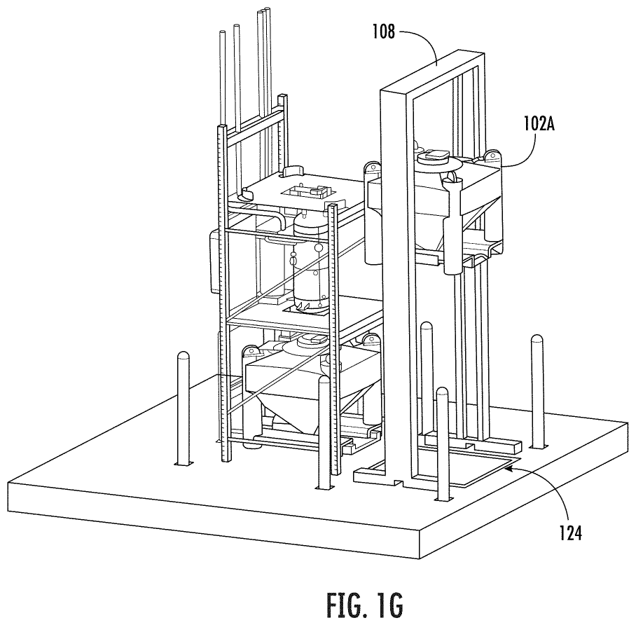

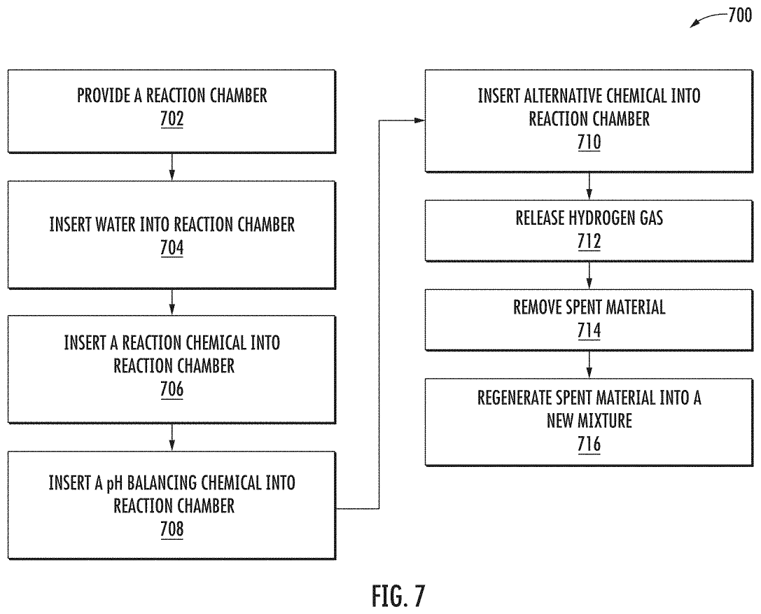

With the exception of reference numerals used for components illustrated in FIG. 1A and FIG. 7, like reference numerals are intended to refer to like elements throughout. Statements herein that a component is “attached” to another component are intended to indicate that these components are directly or indirectly attached together unless stated otherwise.

Further, the term “or” as used in this disclosure and the appended claims is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in,” “at,” and/or “on,” unless the context clearly indicates otherwise. The phrase “in one embodiment,” as used herein does not necessarily refer to the same embodiment, although it may.

Various embodiments are provided with systems and methods for producing hydrogen gas. FIG. 1A is a diagram illustrating an example system 100 for production of hydrogen gas. As shown in FIG. 1A, a first hopper 10 may contain a dry powder mixture comprising sodium borohydride (NaBH₄) and magnesium chloride (MgCl₂). The first hopper 10 may comprise stainless-steel, plastic, or another non-metallic material. In some embodiments, the first hopper 10 may be formed by molding plastic material, but other manufacturing processes may be taken. A connector for an attachment such as a tube may be provided on the first hopper 10. The mixture from first hopper 10 may be drawn into tube by a device such as an auger or piston or gas-controlled microregulator, and the mixture may be fed into a converter 16.

Tap water, sea water, or filtered surface water may be provided in converter 16. An input 18 may be provided to add a controlled amount of tap water, sea water, or filtered surface water, if desired. Input 18 may use a micro-controlled metering valve 20 and a backflow valve 22. As shown, an auxiliary input 24 to converter 16 may be used for the addition of pH balancing chemicals. An alternative chemical component to the magnesium chloride may be present in the dry powder mixture and/or injected into the water as a powder, a liquid, or a paste by utilizing the auxiliary input 24. An emergency pressure vent 25 to outside open air may be provided on converter 16. In some embodiments, multiple emergency pressure vents 25 are provided to provide redundancy. A sensor(s) 26 may be provided at converter 16 for sensing water level, gas pressure, temperature, pH, and other gas and water conditions. A cooling loop 28 with speed-controlled fan may be provided, and this cooling loop 28 may be connected to converter 16 to assist in controlling the temperature in the converter 16. The cooling loop 28 may include an optional chiller. A stirrer may be used in the converter 16 to mix the mixture uniformly in the tap water, sea water, or filtered surface water.

A reaction may occur in the converter 16 to generate hydrogen gas. Hydrogen gas may be released and may exit the top of converter 16. A chiller 35 or another heat exchanger may be provided for dehumidification and/or cooling of hydrogen gas exiting the converter 16. The hydrogen gas may exit at approximately 35 to 65 psig in some embodiments. After a reaction occurs, residual water and residue comprised of salt, borax powder, or a combination thereof may be provided in converter 16. A second hopper 32 may be provided to receive spent material extracted from converter 16 by an auger, piston, or another device However, water may be retained in converter 16 after extraction of spent material. The second hopper 32 may comprise stainless-steel, plastic, or another non-metallic material. In some embodiments, the second hopper 32 may be formed by molding plastic material, but other manufacturing processes may be taken. Spent material may be returned to be regenerated into a new mixture, and this may be returned by ball milling in some embodiments. The second hopper 32 may contain an RFID tag or another device for tracing and/or tracking purposes. The residual water may be drained to a municipal water system 34 and converter 16 thereby washed of any residue build-up.

A similar embodiment of the hydrogen production system 101 is also illustrated in FIGS. 1B-1E. FIG. 1B is a perspective view illustrating an example hydrogen production system 101. FIG. 1C is a rear view illustrating the example hydrogen production system 101 of FIG. 1B. FIG. 1D is a left-side view illustrating the example hydrogen production system 101 of FIG. 1B. FIG. 1E is a top view illustrating the example hydrogen production system 101 of FIG. 1B.

A top hopper 102A may be provided. The top hopper 102A may contain reaction chemicals that are configured to produce hydrogen gas. For example, the top hopper 102A may contain a dry powder mixture comprising sodium borohydride (NaBH₄) and/or magnesium chloride (MgCl₂). However, in some embodiments, only sodium borohydride (NaBH₄) is provided in the top hopper 102A, and magnesium chloride (MgCl₂) may be provided via another hopper or feed line. A bottom hopper 102B may also be provided. The bottom hopper 102B may be used to collect spent fuel material. Spent material collected in the bottom hopper 102B may be returned for regeneration. In some embodiments, the top hopper 102A and the bottom hopper 102B may be identical in shape and dimensions. Additionally, the top hopper 102A may operate similarly to the first hopper 10 described above in reference to FIG. 1A in some embodiments, and the bottom hopper 102B may operate similarly to the second hopper 32 described above in reference to FIG. 1A in some embodiments.

The reaction chamber 104 may be the component where a chemical process takes place. In some embodiments, this reaction chamber 104 may operate similarly to the converter 16 discussed above in reference to FIG. 1A.

A pallet rack 108 may also be provided. The pallet rack 108 may be provided as an automated pallet rack in some embodiments. A support structure 110 may also be provided. The pallet rack 108 and the support structure 110 may provide support for the hoppers 102A, 102B and for other components. Additionally, pallet rack 108 and the support structure 110 may also assist with positioning the hoppers 102A, 102B relative to each other and relative to other components. As illustrated in FIGS. 1F and 1G, the pallet rack 108 may be configured to move relative to the support structure 110. In FIG. 1F, the top hopper 102A is connected to the pallet rack 108, and the pallet rack 108 is positioned so that the top hopper 102A is positioned over the reaction chamber 104 and the bottom hopper 102B. However, as illustrated in FIG. 1G, the pallet rack 108 may be configured to move relative to the support structure 110. As a result, the top hopper 102A may be shifted away from the reaction chamber 104 and the bottom hopper 102B, and the top hopper 102A may be lowered using the pallet rack 108. In FIG. 1G, the pallet rack 108 is illustrated in the loading zone 124.

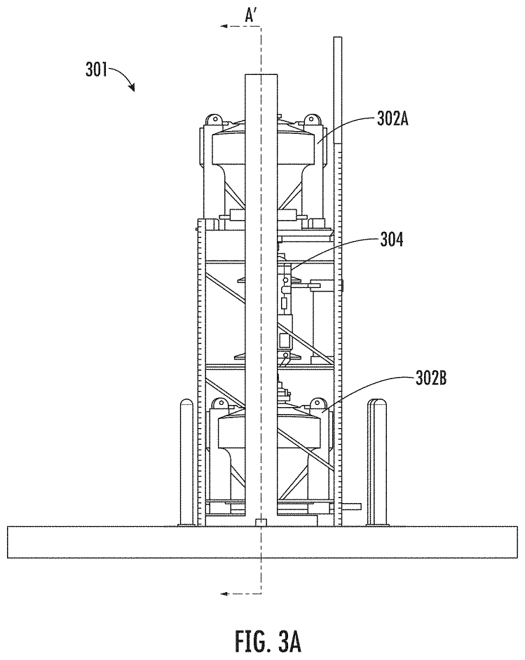

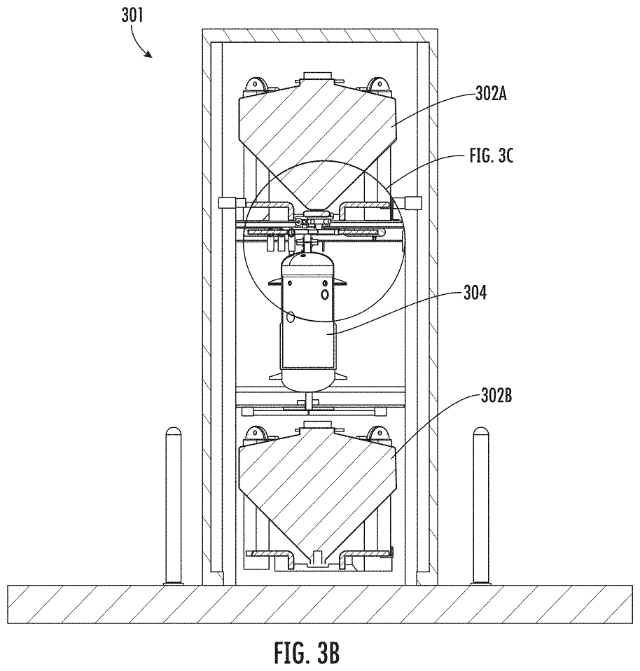

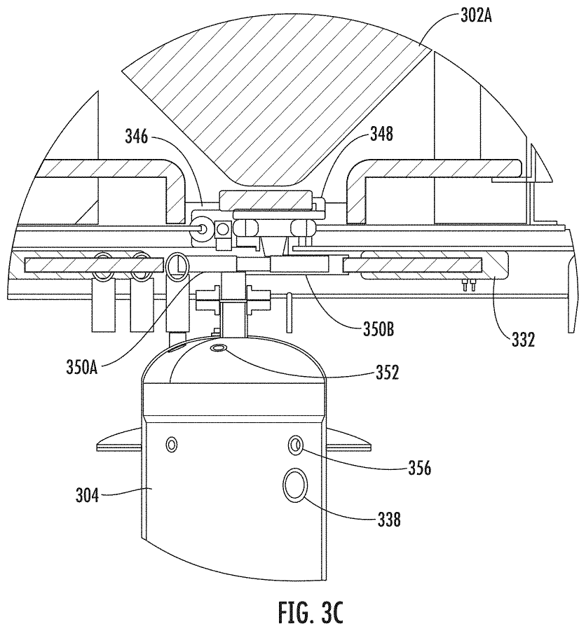

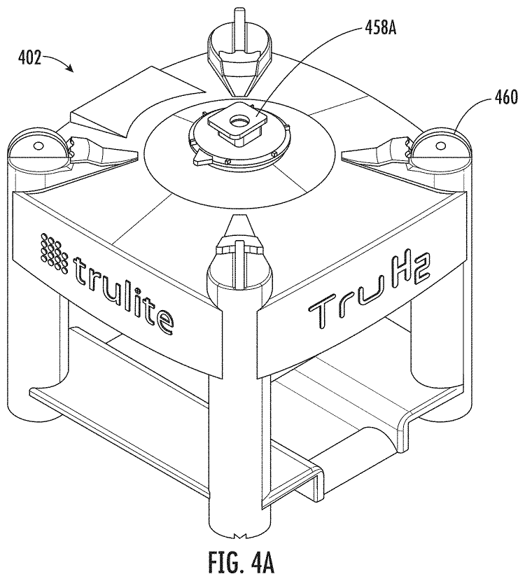

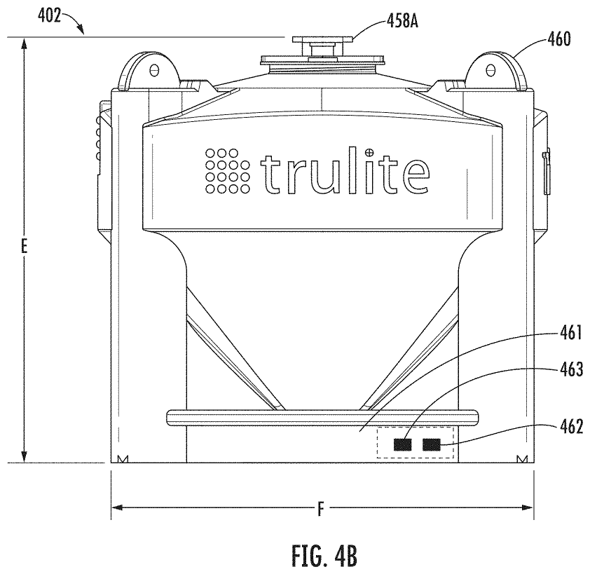

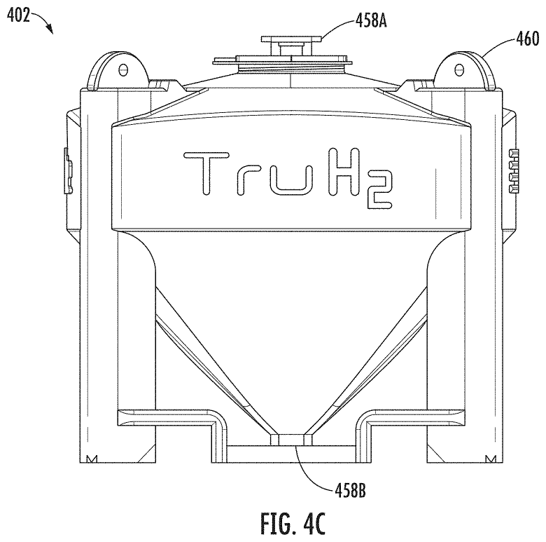

To install the top hopper 102A, the top hopper 102A may be placed in the loading zone 124 and may be connected to the pallet rack 108. The pallet rack 108 may be activated to raise the top hopper 102A to the appropriate height. Once the appropriate height is reached, the pallet rack 108 and the connected top hopper 102A may be shifted so that the top hopper 102A is positioned above the reaction chamber 104. An operator may then connect the top hopper 102A to the reaction chamber 104, or this connection may be accomplished through automated systems. In some embodiments, the connection may be accomplished by engaging a mount flange 458B (see FIG. 4C) on the top hopper 102A with a flange clamp 348 (see FIG. 3C) so that a waterproof and/or vaporproof seal may be provided.

To remove the top hopper 102A after it has been used, the top hopper 102A and the reaction chamber may be disconnected. The top hopper 102A may be connected to the pallet rack 108, and the top hopper 102A and the pallet rack 108 may be shifted to the loading zone 124. The pallet rack 108 may be activated to lower the top hopper 102A, and the top hopper 102A may then be removed from the pallet rack 108 and transported to another location.

A dehumidifier 112 and a radiator 114 may also be provided in some embodiments. The dehumidifier 112 may be connected to a reaction chamber 104, and the dehumidifier may reduce the humidity of vapors and/or chill vapors within the reaction chamber 104. Additionally, the radiator 114 may be used to control the temperature of the inner contents of the reaction chamber 104. The radiator 114 may include a fan in some embodiments, and the radiator 114 may serve as a heat exchanger to lower the temperature of the inner contents of the reaction chamber 104.

One or more vents 116 may also be provided. The vents 116 may be configured to carry hydrogen gas. In the illustrated embodiment, three vents 116 are provided. One of these vents may be electronically controlled, and the other two vents may be manual pressure release vents. However, any number of vents 116 could be used. The vents 116 may be connected to the hydrogen gas output ports 352 (see FIG. 3C) of the reaction chamber 104, and gas valves may be manually and/or automatically controlled to release hydrogen gas from the reaction chamber 104 in a controlled manner. In some embodiments, a chiller 115 or another heat exchanger may be provided for dehumidification and/or cooling of hydrogen gas exiting via the vents 116. The hydrogen gas may exit at approximately 35 to 65 psig in some embodiments.

A water feed line 118 may also be provided. The water feed line 118 may be connected to a water input port 356 (see FIG. 3C) on the reaction chamber 104. A power supply line 120 may also be provided. This power supply line 120 may be used to provide power from a building to the components within the hydrogen production system 101. Where a control panel is connected to components within the hydrogen production system 101 via wired connections, the wired connections may be provided together with the power supply line 120 in some embodiments. However, wired connections between a control panel and components within the hydrogen production system 101 may be routed separately from the power supply line 120 in other embodiments.

Other features such as safety pylons 122 and a loading zone 124 are illustrated in FIG. 1B. One or more safety pylons 122 may be provided as shown to protect the hydrogen production system 101 and other equipment from damage. The loading zone 124 may be used for loading and unloading the top hopper 102A from the example hydrogen production system 101. The pallet rack 108 may be shifted to the loading zone so that the top hopper 102A may be attached or removed from the hydrogen production system 101.

Looking now at FIG. 1C, various dimensions of the hydrogen production system 101 may be seen. Distance A illustrates the height of the pallet rack 108. In some embodiments where a 25CF Model hopper is used, the distance A may be approximately 14 feet and six inches tall, and the hopper 102A may be capable of holding a sufficient amount of the reaction chemical to generate 60 kilograms of hydrogen gas. However, in other embodiments where a 60CF Model hopper is used, the distance A may be approximately 19 feet tall, and the hopper 102A may be capable of holding a sufficient the reaction chemical to generate 140 kilograms of hydrogen gas. It should be understood that embodiments using hoppers of other sizes may be deployed, and the dimensions and the hydrogen gas capacity may take a wide variety of values.

Distance B is also illustrated in FIG. 1C, and it illustrates the width of the pallet rack 108. This distance B is approximately 6 feet in the illustrated embodiment of FIG. 1C, but this distance B may take a wide variety of values. As illustrated in FIG. 1D, the depth of the support structure 110 may be defined by the distance C. This distance C is approximately 4 feet and 5.25 inches in the illustrated embodiment of FIG. 1C, but this distance C may take a wide variety of values.

Also, in FIG. 1E, the distance D is illustrated, and this may define the distance from the support structure 110 to the extreme end of an example loading zone 124. The distance D is approximately 4 feet and 9.19 inches in the illustrated embodiment of FIG. 1E, but the distance D may take a wide variety of values. The loading zone 124 may generally maintain a square shape as illustrated. However, the loading zone 124 may be provided in different locations and with different dimensions in other embodiments.

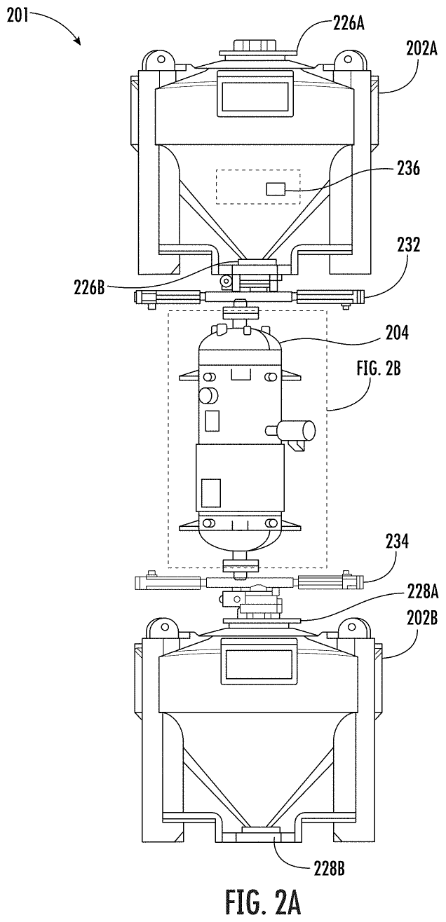

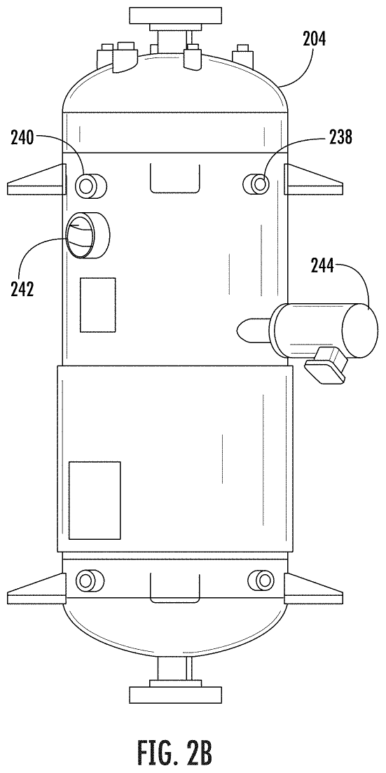

Additional features of the hydrogen production system 201 may be seen in FIGS. 2A-2B. FIG. 2A is a schematic view illustrating an example hydrogen production system 201. FIG. 2B is an enhanced, schematic view illustrating a reaction chamber 204.

A top hopper 202A and a bottom hopper 202B may be provided. These components may be similar to the top hopper 102A and the bottom hopper 102B discussed above. Additionally, the top hopper 202A may include a top slide valve 226A and a bottom slide valve 226B. The bottom hopper 202B may also include a top slide valve 228A and a bottom slide valve 228B. The slide valves 226A, 226B, 228A, 228B may be configured to seal their respective hopper 202A, 202B to keep moisture out of the fuel powder and/or to prevent leakage of spent fuel material. In some embodiments, the top hopper 202A and the bottom hopper 202B may be loaded, sealed, and unsealed using an automated system, and this system may require only one operator during load and unload operations.

In the embodiment illustrated in FIG. 2A, an injector valve 232 and an extractor valve 234 may be provided. The injector valve 232 may be configured to provide little to no release of hydrogen gas into the top hopper 202A. The extractor valve 234 may control the extraction of spent fuel material from the reaction chamber 204. The extractor valve 204 may be configured to optimize water utilization within the reaction chamber 204 to reduce water consumption and to reduce the weight of spent fuel material in the bottom hopper 202B. In some embodiments, the design of the injector valve 232 and the extractor valve 234 may allow for multiple injection or extraction amounts at a programmable frequency and/or amount in a closed loop pressure operated system. The injector valve 232 may be provided between the top hopper 202A and the reaction chamber 204. The injector valve 232 may be adjusted to inject a reaction chemical from the top hopper 202A into the reaction vessel 204, and it may do so while permitting little or no release of hydrogen gas into top hopper 202A.

Additionally, the extractor valve 234 may be provided between the reaction chamber 204 and the bottom hopper 202B. The extractor valve 234 may permit multiple extraction amounts and a programmable frequency and/or amount in a closed loop pressure operated system.

One or more process vibrators 236 may also be provided. Process vibrators 236 may be provided inside the top hopper 202A as illustrated, or process vibrators 236 may be provided outside of the top hopper 202A and in contact with the top hopper 202A. Process vibrators 236 may also be provided at other components such as at the bottom hopper 202B. The process vibrators 236 may clear final residues and valves before sealing.

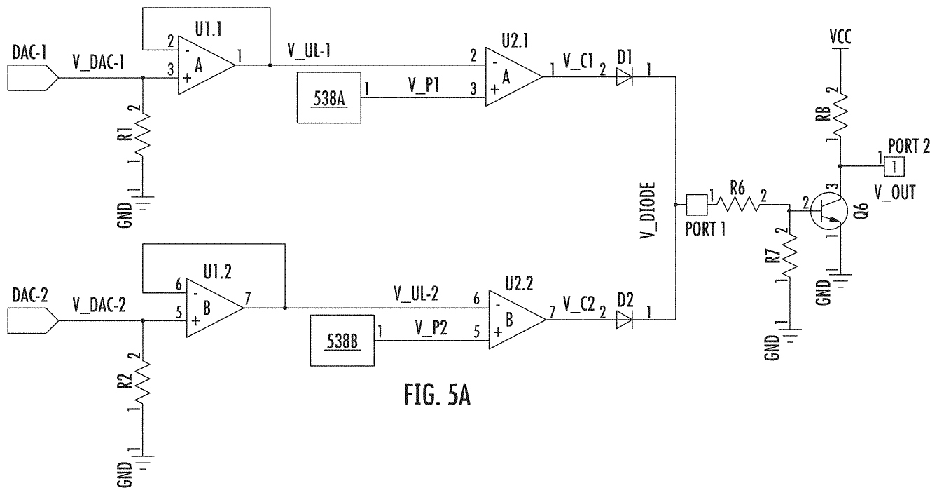

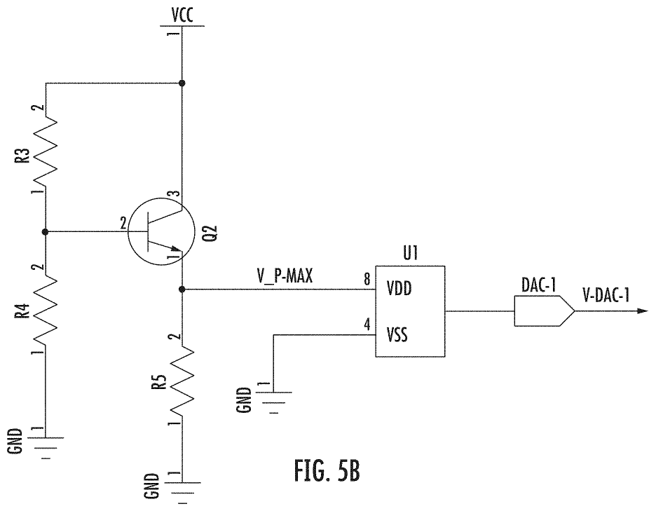

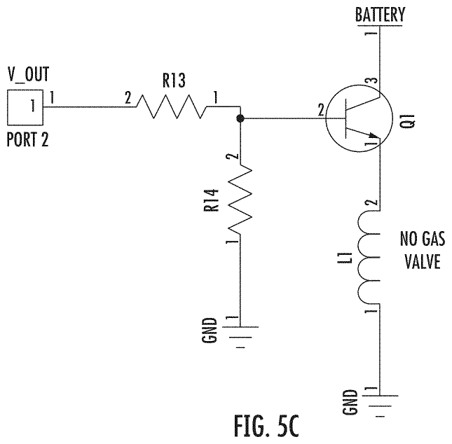

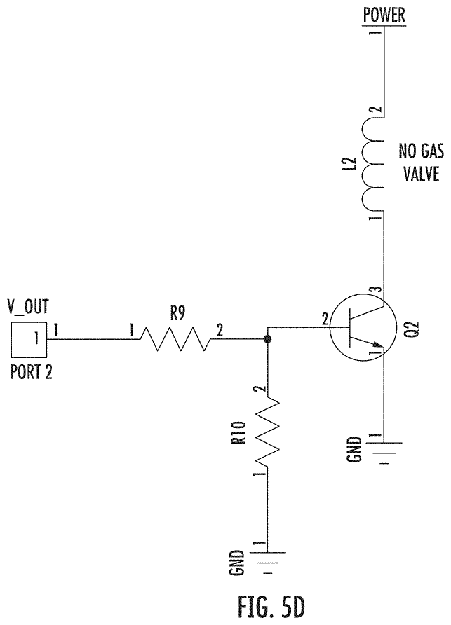

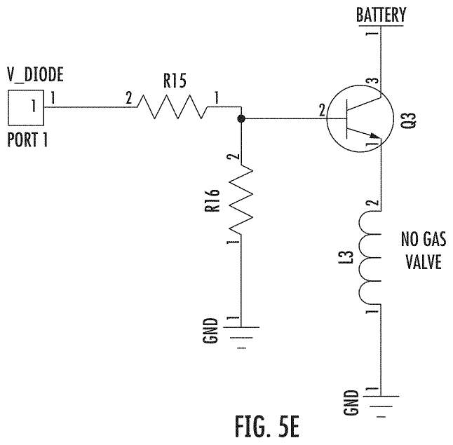

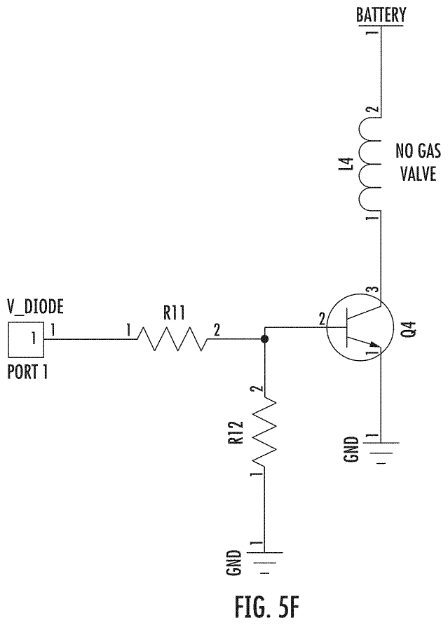

One or more pressure sensors 238 may be provided in the reaction chamber 204 as well. The pressure sensors 238 may be used to facilitate process control of any chemical reactions occurring within the reaction chamber 204. Further details regarding the use of the pressure sensors 238 are provided in reference to FIGS. 5A-5F below. Additionally, other sensors may also be provided to determine properties of the reaction chamber 204. These sensors may, for example, include a temperature sensor and a pH sensor. In some embodiments, the properties of the reaction chamber 204 or other information about the inner contents of the reaction chamber 204 may be presented to an operator via a display. Additionally or alternatively, processing circuitry may be provided with memory having a computer programmable code. The computer programmable code may be configured to cause the processing circuitry to automatically take an action to maintain the inner contents of the reaction chamber 204 in a desired state in response to a sensor moving past a specified threshold.

In some embodiments, two or more gas valves may be provided at the top of the reaction chamber 204, and these gas valves may be redundant of each other. Pressure sensors 238 may be provided alongside the gas valves. Where redundant gas valves are used, the gas valves may operate independently of each other. This may ensure that the pressure in the reaction chamber 204 does not exceed safety limits. These gas valves may each be configured to connect to a separate exhaust piping so that hydrogen gas may be released to the outside atmosphere.

An auxiliary input port 240 may also be provided in the reaction chamber 204. The auxiliary input port 240 may be used for pH balance of the powder chemical mix. By maintaining inner contents of the reaction chamber 204 at a balanced pH level, the amount of water usage may be optimized. In some embodiments, the auxiliary input port 240 may operate similar to the auxiliary input 24 described above in reference to FIG. 1A. Additionally, maintaining the reaction chamber 204 at a balanced pH level may optimize the amount of hydrogen gas and/or spent fuel material. In some embodiments, an ideal pH level may range from 2 to 11. However, the ideal pH level may have other values in other embodiments (e.g. 4 to 9, 5 to 8, etc.). Additionally, various embodiments described herein may deviate from the ideal pH level.

A water feed 242 may also be provided at the reaction chamber 204. This water feed 242 may comprise one or more spray heads inside the reaction chamber 204 to facilitate automated cleaning within the reaction chamber 204. In some embodiments, the water feed 242 may operate similar to the input 18 discussed above in reference to FIG. 1A.

This water feed 242 may be provided as a part of a wash system for the reaction chamber 204. After the reaction chamber 204 is used, a small amount of spent fuel residue that cannot be extracted may be left in the reaction chamber 204. As the reaction chamber 204 is used over time, spent fuel residue may build up within the reaction chamber 204 if nothing is done to clean the reaction chamber 204. Washing the reaction chamber 204 may help reduce or prevent the buildup of spent fuel residue in the reaction chamber 204. By reducing the buildup of this spent fuel residue, the chemical processes occurring in the reaction chamber 204 may be more efficient and may generate a greater amount of hydrogen gas.

An agitator 244 may also be provided in the reaction chamber 204. This agitator 244 may be a variable speed agitator in some embodiments. The agitator 244 may be provided at a water line within the reaction chamber 204 in some embodiments, and the agitator may ensure that no powder skin or residue will build up on the water surface. By doing so, the material in the reactor 204 may be mixed so that it maintains more uniform properties. By using the agitator 244, the reaction that occurs with each injection will remain consistent, and the efficiency of the chemical reactions occurring within the reaction chamber 204 may be optimized. The agitator 244 may be operated at a high speed during a wash cycle to optimize cleaning and water usage. In some embodiments, the variable speed agitator may be configured to operate at a low speed of approximately 1 revolution per minute. Additionally, the variable speed agitator may be configured to operate at a high speed of 500 revolutions per minute in some embodiments, but the variable speed agitator may be configured to operate at other rotational speeds or within other speed ranges in other embodiments.

Further features of a hydrogen production system 301 may be seen in FIGS. 3A-3C. FIG. 3A is a right-side view illustrating an example hydrogen production system 301. FIG. 3B is a cross-sectional view illustrating the example hydrogen production system 301 of FIG. 3A about the line A′-A′. FIG. 3C is an enhanced view illustrating the connection of a top hopper 302A and a reaction chamber 304.

As illustrated in FIGS. 3A and 3B, a top hopper 302A, a reaction chamber 304, and a bottom hopper 302B are provided. These components may be similar to the top hoppers 102A, 202A, the reaction chambers 104, 204, and the bottom hoppers 102B, 202B described above.

Looking now at FIG. 3C, the injector valve 332 may be similar to the injector valve 232 (see FIG. 2A) described above. The injector valve 332 may include a first isolating drive ram 350A and a second isolating drive ram 350B. An automated solenoid valve 346 may be used to control the flow of reaction chemicals from the top hopper 302A to the bottom hopper 302B.

One or more pressure sensors 338 may also be provided, and the pressure sensors 338 may operate similar to the pressure sensors 238 described above.

ASME flange clamps 348 may also be provided. These ASME flange clamps 348 may be provided as universal ASME flange clamps in some embodiments, and the ASME flange clamps 348 may be configured to provide a vapor/waterproof seal. In some embodiments, the flange clamps 348 may be configured to engage mount flanges 458A, 458B (see FIGS. 4A-4C) to form a seal. By providing a proper seal, the hoppers 302A and 302B may have an improved shelf life. In some embodiments, the hoppers 302A and 302B may even have an unlimited shelf life.

Other ports may also be provided at the reaction chamber 304. A hydrogen gas output port 352 may also be provided. This hydrogen gas output port 352 may be provided at an upper portion of the reaction chamber 304 above the water line within the reaction chamber 304. The hydrogen gas output port 352 may be configured to connect to a vent 116 (see FIG. 1C) or to another component to extract hydrogen gas from the reaction chamber 304.

A water input port 356 may also be provided on the reaction chamber 304. The water input port 356 may configured to connect to a water feed line 118 (see FIG. 1C) or to another component so that water may be provided to the reaction chamber 304. In some embodiments, a valve is provided to control the flow of water into the reaction chamber 304. The valve may be controlled so that it will only permit a specified amount of water to enter the reaction chamber 304 at a specified time.

Hoppers 402 that may be used in the aforementioned hydrogen production systems are illustrated in FIGS. 4A-4C. FIG. 4A is a perspective view illustrating an example hopper 402. FIG. 4B is a right-side view illustrating the hopper 402 of FIG. 4A. FIG. 4C is a front view illustrating the hopper 402 of FIG. 4A. The hopper 402 may include ASME mount flange 458A, 458B to facilitate the flow of material into and/or out of the hopper 402. In the illustrated embodiment, a top mount flange 458A and a bottom mount flange 458B may be provided, and these mount flanges may be identical. The mount flanges 458A, 458B may be configured to engage with an ASME flange clamp 348 (see FIG. 3C) so that a waterproof and/or vaporproof seal may be provided.

The hopper 402 may also include lifting sections 460. In the illustrated embodiment, the hopper 402 includes four different lifting sections 460 at the top of the hopper 402. However, a greater or lesser number of lifting sections 460 may be provided in other embodiments. Cables and/or other components may be connected to the lifting sections 460 so that the hopper 402 may be moved. The hopper 402 may be very heavy, especially when the hopper 402 is filled. Thus, heavy machinery may be necessary to raise, lower, and otherwise move the hopper 402. The lifting sections 460 may permit operators to easily lift and move the hopper 402.

Looking now at FIG. 4B specifically, a bottom section 461 of the hopper 402 is illustrated. Additionally, a portion of the internal contents of the bottom section 461 is illustrated in FIG. 4B. One or more RFID tags 462 may be provided in the hopper 402 in some embodiments. One RFID tag 462 is illustrated as being within the bottom section 461 in the illustrated embodiment in FIG. 4B, but the RFID tags 462 may be provided at other locations. The RFID tags 462 may be molded into the hopper 402 in some embodiments, but the RFID tags 462 may be secured in other ways. The RFID tags 462 may be read/write RFID tags. The RFID tags 462 may prevent unauthorized refilling or unsafe operation of the hopper 402. In some embodiments, a GPS locator 463 may be provided alongside or as an alternative to the RFID tags 462. A GPS locator 463 may be provided at the hopper 402 to enable pinpoint location of a hopper 402. The GPS locator 463 may be provided inside the bottom section 461 of the hopper 402 in some embodiments, but the GPS locator 463 may be provided in other locations.

Looking now at FIG. 4B, the distance E may define the height of the hopper 402. In some embodiments where a 25CF Model is used, the height of the hopper 402 is approximately 48 inches. Additionally, where the 25CF Model is used, the hopper 402 may be capable of holding a sufficient amount of the reaction chemical to generate 60 kilograms of hydrogen gas. In other embodiments were a 60CF Model is used for the hopper 402, the height of the hopper 402 is approximately 76 inches. Additionally, where the 60CF Model is used, the hopper 402 may be capable of holding a sufficient amount of the reaction chemical to generate 140 kilograms of hydrogen gas. It should be understood that embodiments using other heights may be deployed, and the dimensions and the hydrogen gas capacity may take a wide variety of values.

The distance F may define the width of the hopper 402. In some embodiments, the hopper 402 may possess the same width on the front side, the left side, the back side, and the right side. The distance F may be approximately 4 feet in some embodiments, but other widths may be provided in other embodiments.

In some embodiments, one hopper 402 may be easily stacked onto another hopper 402. This may reduce the amount of space required for storage of the hopper 402, and this may also reduce the space required within transportation vehicles to transport hoppers 402 from one location to another.

In some embodiments, a system is provided for ensuring that the pressure inside a reaction chamber 104 (see FIG. 1B) does not exceed a defined maximum pressure. FIG. 5A is an electrical diagram illustrating processing circuitry that may be used to operate a system for managing the pressure within a reaction chamber 104 (see FIG. 1B). This system may utilize redundant hardware logic and software controls. For example, two independent pressure sensors 538A, 538B may be provided in some embodiments. These pressure sensors 538A, 538B may measure the pressure within the reaction chamber 104 (see FIG. 1B). The pressure sensors 538A, 538B may also convert the pressure inside the reaction chamber 104 to a proportional voltage or the pressure sensors 538A, 538B may be connected to one or more additional components that are configured to convert the pressure readings to a proportional voltage. The voltages generated by the pressure sensors 538A, 538B are referred to as V_P1 and V_P2 in FIG. 5A.

In some embodiments, processing circuitry may be provided with memory having a computer programmable code. The computer programmable code may be configured to cause the processing circuitry to control the provision of chemicals to the reaction chamber 104 (see FIG. 1B). The computer programmable code may be configured to cause the processing circuitry to control the type of chemicals that are introduced into the reaction chamber 104, the amount of chemicals that are introduced, and/or the timing for when chemicals are introduced. This may, for example, be done by sending commands and/or electrical signals to an injector valve 232 (see FIG. 2A). In some embodiments, computer programmable code may be configured to cause processing circuitry to prevent any additional chemicals from being added into the reaction chamber 104 when the pressure inside the reaction chamber 104 (see FIG. 1B) exceeds a specified threshold. The chemicals may undergo a chemical reaction in the reaction chamber 104. The reaction may produce hydrogen gas (H2), resulting in an increased pressure in the reaction chamber 104. The reaction may also be an exothermic reaction, generating increased heat within the reaction chamber 104. The computer programmable code may also include algorithms that may be deployed to predict the resulting pressure in the reaction chamber 104 over time. These algorithms may provide expected maximum pressure values at a given time.

The expected maximum pressure value(s) may be converted to an analog voltage using a digital to analog converter. In the illustrated embodiment of FIG. 5, two digital to analog converters DAC 1 and DAC 2 are provided. DAC 1 and DAC 2 may provide limit voltages V_DAC-1 and V_DAC-2, and these limit voltages may be provided to comparators U1.1 and U1.2 respectively. The limit voltages V_DAC-1 and V_DAC-2 may have greater stability than other voltages such as the voltages V_P1 and V_P2 produced by the pressure sensors 538A, 538B. In some embodiments, the voltages V_DAC-1 and V_DAC-2 may be within the same general range as the voltages V_P1 and V_P2 produced by the pressure sensors 538A, 538B. While analog voltages are produced from digital values in FIG. 5, other approaches may be taken as well. For example, V_DAC-1 and V_DAC-2 may be provided without the use of any digital to analog converter DAC 1 and DAC 2 in some embodiments. Pull-down resistors R1 and R2 at the input of DAC 1 and DAC 2 may be provided, and these pull-down resistors R1, R2 may ensure that the limit voltages will stay low if a digital to analog converter fails or is disconnected.

An emitter follower circuit is illustrated in FIG. 5B as an example approach for limiting the DAC voltage. The DAC voltage may be limited by a rail-to-rail operational amplifier U1 in some embodiments. The amplifier U1 may be powered by the maximum pressure sensor voltage (V_P-MAX) allowed in the reaction chamber 104 (see FIG. 1B). The voltage may be buffered by any acceptable means to provide sufficient current to power the operational amplifier U1. For example, the voltage may be buffered by a transistor Q2. While one circuit is illustrated in FIG. 5B to limit the voltage V_DAC-1 moving through the first digital to analog converter DAC-1, another similar circuit may also be provided to limit the voltage V_DAC-2 moving through the second digital to analog converter DAC-2.

The resistor R5 may limit the maximum current in the transistor Q2. The transistor Q2 may be an NPN transistor in some embodiments. The maximum pressure sensor voltage V_P-MAX may be defined by the following formula:

V_P-MAX=VCC*(R4/(R3+R4))−0.7

Looking back at FIG. 5A now, comparator U2.1 may receive a voltage V_UL-1 from the first digital to analog converter DAC-1. Comparator U2.1 may also receive a voltage V-Pl from the first pressure sensor 538A. The comparator U2.1 may compare the voltage V_UL-1 to the voltage V-P1. If the voltage V_P1 is less than the voltage upper limit V_UL-1, then the output voltage V_C1 for the comparator U2.1 may be set to a low voltage, which may be approximately zero in some embodiments. If the voltage V_P1 is greater than or equal to the voltage upper limit V_UL-1, then the output voltage V_C1 for the comparator U2.1 may be set to a high voltage, which may be a positive voltage value or a voltage near VCC in some embodiments. The output voltage V_C1 of the comparator U2.1 may be fed to a diode D1.

Comparator U2.2 may receive a voltage V_UL-2 from the second digital to analog converter DAC-2, and the comparator U2.2 may also receive a voltage V-P2 from the second pressure sensor 538B. The comparator U2.2 may compare the voltage V_UL-2 to the voltage V-P2. If the voltage V_P2 is less than the voltage upper limit V_UL-2, then the output voltage V_C2 for the comparator U2.2 may be set to a low voltage, which may be approximately zero in some embodiments. If the voltage V_P2 is greater than or equal to the voltage upper limit V_UL-2, then the output voltage V_C2 for the comparator U2.2 may be set to a high voltage, which may be a positive voltage value or a voltage near VCC in some embodiments. The output voltage V_C2 of the comparator U2.2 may be fed to a diode D2.

The two diodes D1 and D2 may combine to generate a voltage V_DIODE at a resistor R6, and a high voltage from either comparator U2.1 or U2.2 may produce a high voltage V_DIODE at R6. A transistor Q6 may be provided, and this may be an NPN transistor in some embodiments. The resistor R6 may act as a current limiter to the base of the transistor Q6, and the resistor R7 may act as a voltage divider. Unless U2.1 or U2.2 (or both) are set to a high voltage through D1 or D2 (or both), the resistor R7 may pull down to keep the transistor Q6 turned off. The resistor R8 may pull the voltage V_OUT up to VCC when the transistor Q6 is turned off. A positive voltage at R6 (V_DIODE) may turn the transistor Q6 on and may pull the voltage V_OUT down to GND.

V_OUT may be used to control one or more gas valves associated with hydrogen gas output ports 352 (see FIG. 3C) attached to the reaction chamber 104 (see FIG. 1B). The gas valves may be powered by a solenoid and controlled through various approaches. The output voltage V_OUT may be a high voltage when both voltages V_P1 and V_P2 are below voltages V_UL-1 and V_UL-2 respectively. However, if the voltage V_P1 is greater than or equal to the voltage V_UL-1 or if the voltage V_P2 is greater than or equal to the voltage V_UL-2, then the output voltage V_OUT may be set to a low value.

Various approaches for controlling the gas valves are illustrated in FIG. 5C-5F. Starting with FIG. 5C, a gas valve of the normally open (NO) type may be provided, and the gas valve may be provided in the form of a solenoid valve. Gas may flow through the gas valve when no power is applied to the gas valve. V_OUT may be buffered by a transistor Q1 to provide the proper voltage (POWER) and sufficient current. The transistor Q1 may be an NPN transistor in some embodiments. Switched POWER may be applied to the upper leg of the gas valve. POWER may keep the gas valve closed so that gas may not flow through the gas valve. If the pressure of the reaction chamber 104 (see FIG. 1B) rises above the upper limit, then V_OUT may drop to GND, the transistor Q1 may turn off so that no power will be applied to the gas valve, and gas may flow through the gas valve. Resistor R14 may ensure that the transistor Q1 remains off unless V_OUT is high.

FIG. 5D illustrates another approach for controlling a gas valve. In the approach illustrated in FIG. 5D, the gas valve may be of the normally open (NO) type, and the gas valve may be provided in the form of a solenoid valve. Gas may flow through the gas valve when no power is applied. V_OUT may be buffered by the transistor Q2 to provide the proper voltage (POWER) and sufficient current. The transistor Q2 may be an NPN transistor in some embodiments. V_OUT may be buffered by the transistor Q2 and applied as a GND signal to the lower leg of the gas valve. POWER may be applied to the upper leg the gas valve. POWER may keep the gas valve closed when the transistor Q2 is active so that gas may not flow through the gas valve. If the pressure of the reaction chamber 104 (see FIG. 1B) rises above the upper limit, then V_OUT may drop to GND and the transistor Q2 may turn off. As a result, no power will be applied to the gas valve and gas may be permitted to flow through the gas valve. The resistor R10 may ensure that the transistor Q2 will remain off unless V_OUT is high.

Looking now at FIG. 5E, another approach for controlling a gas valve is provided. This approach uses a gas valve of the normally closed (NC) type. Gas may flow through the gas valve only when power is applied. V_DIODE may be buffered by the transistor Q3 to provide proper voltage (BATTERY) and sufficient current. The transistor Q3 may be a NPN transistor in some embodiments. A GND signal may be applied to the lower leg of the gas valve, and BATTERY may be applied to the gas valve to keep it open when the transistor Q3 is active. If the pressure in the reaction chamber 104 (see FIG. 1B) rises above the upper limit, V_DIODE may rise and the transistor Q3 may be active, and gas may be permitted to flow through the gas valve. The resistor R16 may ensure that the transistor Q3 will remain active unless V_DIODE is low. Where the approach of FIG. 5E is taken, a battery backup supply will preferably be provided to allow the gas valve to open even when system power is lost.

FIG. 5F illustrates another approach that may be used to control a gas valve. The gas valve may be a normally closed (NC) type gas valve. Gas may flow through the gas valve only when power is applied. V_DIODE may be buffered by the transistor Q4 to provide proper voltage (BATTERY) and sufficient current. The transistor Q4 may be a NPN transistor in some embodiments. BATTERY may be applied to the upper leg of the gas valve and GND may be applied to the gas valve to keep the gas valve open when the transistor Q4 is active. If the pressure within the reaction chamber 104 (see FIG. 1B) rises above the upper limit, then V_DIODE may rise and the transistor Q4 may be active, and gas may be permitted to flow through the gas valve. The resistor R12 may ensure that the transistor Q4 will remain active unless V_DIODE is low. Where the approach of FIG. 5F is taken, a battery backup supply will preferably be provided to allow the gas valve to open even when system power is lost.

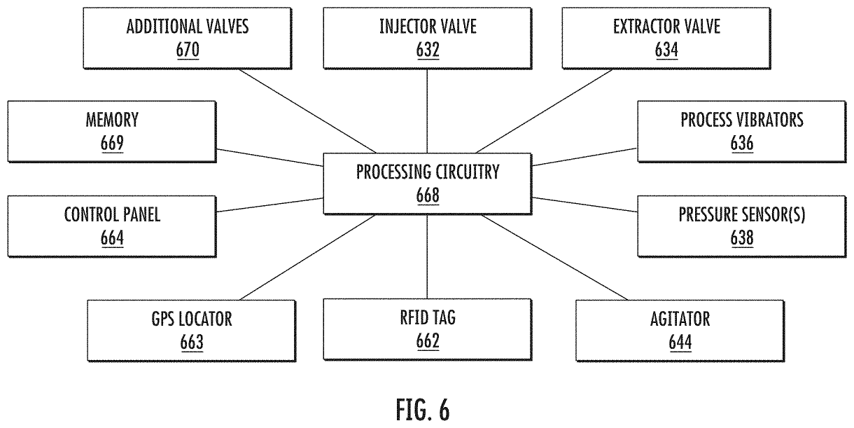

Processing circuitry may be connected to various electrical components and other components within the hydrogen production system, and FIG. 6 illustrates various components that may be used in one embodiment. As illustrated, processing circuitry 668 may be provided, and this processing circuitry 668 may be connected to various components. The processing circuitry 668 may, for example, be connected to various valves. These valves may include an injector valve 632, an extractor valve 634, and additional valves 670 such as valves associated with the auxiliary input port 240 (see FIG. 2B) and the water input port 356 (see FIG. 3C). The processing circuitry 668 may also be connected to other components at the reaction chamber 104 (see FIG. 1B), including process vibrators 636, pressure sensor(s) 638, and an agitator 644. Additionally, the processing circuitry 668 may also be connected to components within the hoppers 402 (see FIG. 4A) such as an RFID tag 662 and/or a GPS locator 663. The processing circuitry 668 may also be connected to memory 669 and to a control panel 664, and the control panel 664 may have an interface and an associated display where an operator may adjust the operation of the hydrogen production system.

While various components are illustrated in FIG. 6, it should be understood that additional components may be utilized and that certain components described above may be omitted. Additionally, various connections are illustrated in FIG. 6. These connections may be wired connections or wireless connections. Wireless connections may be made through Wi-Fi, Bluetooth, Bluetooth Low Energy, cellular or other forms of wireless connections. Connections may be altered in other embodiments.

Processing circuitry described herein may comprise one or more processors, microprocessors, controllers, microcontrollers, and other computing devices.

FIG. 7 is a flow chart illustrating an example method for producing hydrogen gas in accordance with an embodiment of the present invention. Starting at operation 702, a reaction chamber may be provided. The reaction chamber may be similar to the reaction chamber 104 (see FIG. 1B) and other reaction chambers described above.

At operation 704, water may be inserted into the reaction chamber. As described above, water may be inserted into the reaction chamber via input 18 (see FIG. 1A), a water feed 242 (see FIG. 2B), a water input port 356 (see FIG. 3C). In some embodiments, water may be metered into the reaction chamber at a controlled rate. This may control the rate of chemical reactions in the reaction chamber where a reaction chemical is present in the reaction chamber or where spent material from previous reactions remains in the reaction chamber.

At operation 706, a reaction chemical may be inserted into the reaction chamber. The reaction chemical may be metered into the reaction chamber at a controlled rate, and the reaction chemical may be inserted into the reaction chamber after water is inserted into the reaction chamber in some embodiments. The reaction chemical may be selected that will undergo a chemical reaction with water within the reaction chamber so that hydrogen gas is produced. In some embodiments, the reaction chemical may be sodium borohydride (NaBH₄). The reaction chemical may be provided as a dry powder.

At operation 708, a pH balancing chemical may be inserted into the reaction chamber. Inserting this pH balancing chemical may ensure that any spent solid chemical mixture that is produced in a reaction has a balanced pH level.

At operation 710, an alternative chemical component may be inserted into the reaction chamber. This alternative chemical component may be inserted into the reaction chamber alongside the reaction chemical. The alternative chemical component may be magnesium chloride (MgCl₂). In some embodiments, the alternative chemical component may be added into the reaction chamber as a liquid or a paste. Chemical components include a chemical element and chemical compound for the purposes of this application.

At operation 712, hydrogen gas generated by the chemical reaction within the reaction chamber may be released. The hydrogen gas may be released into the surrounding environment via vents 116 (see FIG. 1B), and pressure sensors 538A, 538B and processing circuitry described above in reference to FIGS. 5A-5F may be used to control the release of hydrogen gas from the reaction chamber in some embodiments.

At operation 714, spent material may be removed from the reaction chamber. In some embodiments, removed spent material may be deposited in a hopper. The removed spent material may be deposited in an empty hopper, and the hopper may be similar to the hopper 402 (see FIG. 4A-4C) discussed above in various embodiments. In some embodiments, spent material may be removed from the reaction chamber while water is present in the reaction chamber. At operation 716, the removed spent material may be regenerated in a new mixture.

While various operations are discussed and illustrated in FIG. 7, it should be understood that these operations may be performed in any order unless otherwise noted. Additionally, operations may be added, removed, and/or performed simultaneously.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. A method for producing hydrogen gas, the method comprising:
metering a reaction chemical at a controlled rate into a reaction chamber containing water,
wherein a reaction thereby occurs in the reaction chamber releasing hydrogen gas, and
wherein the reaction chemical comprises sodium borohydride (NaBH₄) and a chemical component.

2. The method of claim 1, wherein the chemical component is magnesium chloride (MgCl₂).

3. The method of claim 1, wherein the reaction chamber is a stationary chemical converter.

4. The method of claim 1, wherein the reaction chemical is a dry powder.

5. The method of claim 1, further comprising removing or extracting a resulting spent chemical mixture from the reaction chamber.

6. The method of claim 5, further comprising depositing the resulting spent chemical mixture in an empty fuel supply hopper for return and regeneration.

7. The method of claim 1, wherein the reaction chamber has a wash and surface water cycle capable of removing any residue in the reaction chamber.

8. The method of claim 6, wherein the spent chemical mixture has a pH balanced low mineral or salt content.

9. The method of claim 1, further comprising adding a pH balancing chemical the reaction chamber.

10. The method of claim 1, further comprising adding an alternative chemical component to the reaction chamber as a liquid or a paste.

11. The method of claim 5, wherein the spent chemical mixture is removed or extracted from the reaction chamber while the water is held in the reaction chamber.

12. The method of claim 5, further comprising regenerating the spent material into a new mixture.

13. A system for producing hydrogen gas, the system comprising:
a first hopper comprising a reaction chemical,
wherein the reaction chemical comprises sodium borohydride (NaBH₄) and a chemical component, and wherein the chemical component is magnesium chloride (MgCl₂);
a reaction chamber having an input for receiving the reaction chemical from the first hopper and having an output for removal of hydrogen gas; and
a second hopper for containing a spent chemical mixture removed or extracted from the reaction chamber.

14. The system of claim 13, further comprising an automated pallet rack that is configured to connect with the first hopper, wherein the automated pallet rack is configured to automatically raise and automatically lower the first hopper.

15. The system of claim 14, wherein the pallet rack is configured to move laterally relative to the reaction chamber.

16. The system of claim 14, further comprising an ASME flange clamp, wherein the first hopper comprises a first mount flange, wherein the first mount flange is configured to be engaged with the ASME flange clamp to form a seal.

17. The system of claim 16, wherein the first mount flange is configured to be automatically engaged with the ASME flange clamp.

18. A system for producing hydrogen gas comprising:
a first hopper configured to hold a reaction chemical;
a second hopper configured to hold a spent chemical mixture;
a reaction chamber connected to the first hopper and the second hopper and positioned between the first hopper and the second hopper, the reaction chamber having
an input for receiving the reaction chemical from the first hopper;
an output vent for removal of hydrogen gas;
a gas valve that is configured to permit or prevent flow of gas through the output vent;
an output for removal of the spent chemical mixture to the second hopper; and
at least one pressure sensor; and
an electrical system having a comparator, wherein the electrical system is configured to:
receive a first value from the at least one pressure sensor;
compare the first value to an upper limit using the comparator;
open the gas valve or retain the gas valve in an open state if the first value is greater than or equal to the upper limit.

19. The system of claim 18, wherein the at least one pressure sensor includes two or more pressure sensors, wherein the two or more pressure sensors are redundant.

20. The system of claim 18, wherein the reaction chemical comprises sodium borohydride (NaBH₄) and magnesium chloride (MgCl₂).

21. The system of claim 18, further comprising a transistor.

22. The system of claim 21, wherein the gas valve is a normally open gas valve, wherein the electrical system is configured to activate the transistor to cause the gas valve to close or remain closed when the first value is less than the upper limit, wherein the electrical system is configured to deactivate the transistor to cause the gas valve to open or remain opened when the first value is greater than or equal to the upper limit.

23. The system of claim 22, wherein the gas valve is a normally closed gas valve, wherein the electrical system is configured to deactivate the transistor to cause the gas valve to close or remain closed when the first value is less than the upper limit, wherein the electrical system is configured to activate the transistor to cause the gas valve to open or remain opened when the first value is greater than or equal to the upper limit.
